(19) United States
(12) Patent Application Publication
(10) Pub. No.: US 2008/0181102 A1
(43) Pub. Date: Jul. 31, 2008

(54) NETWORK ROUTING

(75) Inventor: Christopher N. Del Regno, Rowlett, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Irving, TX (US)

(21) Appl. No.: 11/627,028

(22) Filed: Jan. 25, 2007

(51) Int. Cl. H04J 3/14

(52) U.S. Cl. 370/223; 370/392

(57) ABSTRACT

In a network including a number of nodes configured to support multi-protocol label switching, a method may include forming a primary label switching path (LSP) from a first one of the nodes to the other ones of the nodes in a first direction. The primary LSP may form a first ring-like LSP including each of the nodes. The method may also include forming a secondary LSP from the first node to the other ones of the nodes in a second direction opposite the first direction. The secondary LSP may form a second ring-like LSP including each of the nodes.

### BACKGROUND INFORMATION

Routing data in a network has become increasing complex due to increased data speeds, the amount of traffic, etc. As a result, network devices often experience congestion related problems and may fail. Links connecting various network devices may also experience problems and/or fail. When a failure occurs, the traffic must be re-routed to avoid the failed device and/or failed link.

### BRIEF DESCRIPTION OF THE DRAWINGS

FIG. 1 illustrates an exemplary network in which systems and methods described herein may be implemented;

FIG. 2 illustrates an exemplary configuration of a multi-protocol label switching device of FIG. 1;

FIG. 3 is a flow diagram illustrating exemplary processing by various devices illustrated in FIG. 1;

FIG. 4 illustrates the routing of data via a backup path in the network of FIG. 1; and

FIG. 5 illustrates the re-establishment of a primary path in the network of FIG. 1.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention. Instead, the scope of the invention is defined by the appended claims and their equivalents.

Implementations described herein relate to network communications and configuring primary paths and backup paths in a network. When the primary path is not available, data may be automatically re-routed on the backup path. In one implementation, the primary and backup paths may be configured in a ring-link arrangement.

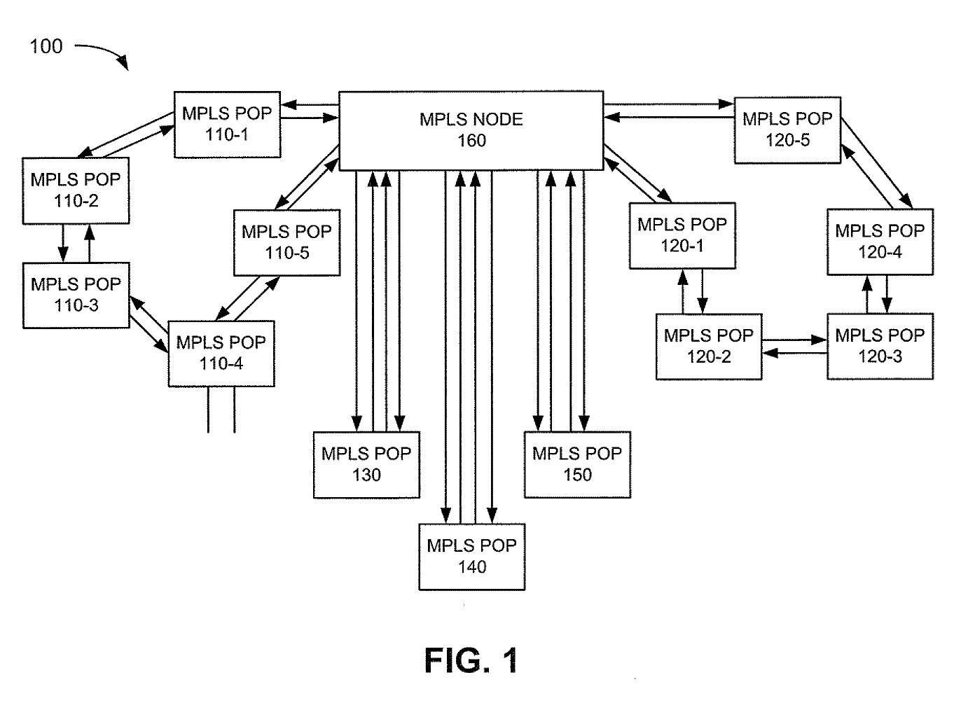

FIG. 1 is a block diagram of an exemplary network 100 in which systems and methods described herein may be implemented. Network 100 may include a number of multi-protocol label switching (MPLS) points of presence (POPs) 110-1 through 110-5, referred to collectively as MPLS POPs 110, MPLS POPs 120-1 through 120-5, referred to collectively as MPLS POPs 120, and MPLS POPs 130, 140 and 150. Network 100 may also include MPLS node 160.

MPLS POPs 110 may each include a network device or node (e.g., a switch, a router, etc.) that receives data and uses an MPLS label included with a data packet to identify a next hop to which to forward the data. For example, an MPLS POP, such as MPLS POP 110-1, may receive a packet that includes an MPLS label in the header of the data packet. The MPLS POP may then use the label to identify an output interface on which to forward the data packet without analyzing other portions of the header, such as a destination address. The next hop for the data packet, such as MPLS POP 110-2 may be part of a label switching path (LSP) set up between various MPLS nodes. For example, MPLS POPs 110-1 through 110-5 may form a ring-like LSP with an LSP set up in each direction, as illustrated by the arrows in each direction in FIG. 1. Similarly, MPLS POPs 120-1 through 120-5 may set up a ring-like LSP in which each of the MPLS POPs 120-1 through 120-5 form an LSP with neighboring MPLS POPs in both directions. If a problem occurs on one of the MPLS POPs and/or on a link connecting the MPLS POPs, data may be routed on the LSP in an opposite direction, as described in detail below.

MPLS POPs 130, 140 and 150 may connect to MPLS node 160. Each of MPLS POPs 130, 140 and 150 may include multiple paths (e.g., LSPs) to MPLS node 160. In this manner, if one of the paths fails, another path may be used to route the data to MPLS node 160.

MPLS node 160 may represent a termination point of an LSP. For example, MPLS node 160 may route data received via the LSP to its ultimate destination (e.g., user device, customer provided equipment, etc.) using the destination address included in the data packet, as opposed to a label. MPLS node 160 may also represent a control device configured to control the setup of various LSPs in network 100, as described in detail below.

In an exemplary implementation, MPLS node 160 and/or one or more of MPLS POPs 110-1 through 110-5 may be coupled to, for example, a layer 2 network, such as an Ethernet network. In this case, the layer 2 network may couple MPLS node 160 and/or one of MPLS POPs 110 to an end user device, customer provided equipment, etc.

The exemplary configuration illustrated in FIG. 1 is provided for simplicity. It should be understood that a typical network may include more or fewer devices than illustrated in FIG. 1. In addition, MPLS node 160 is shown as a separate element from the various MPLS POPs in FIG. 1. In other implementations, the functions performed by MPLS node 160 and MPLS POPs, described in more detail below, may be performed by a single device or node.

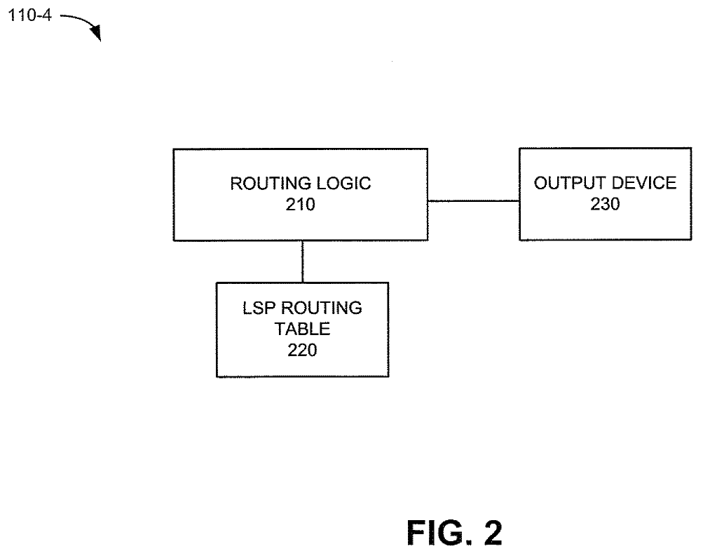

FIG. 2 illustrates an exemplary configuration of an MPLS POP, such as MPLS POP 110-4. The other MPLS POPs in FIG. 1 (e.g., MPLS POPs 120-150 and the other MPLS POPs 110) may be configured in a similar manner. Referring to FIG. 2, MPLS POP 110-4 may include routing logic 210, LSP routing table 220 and output device 230.

Routing logic 210 may include a processor, microprocessor, application specific integrated circuit (ASIC), field programmable gate array (FPGA) or another logic device or component that receives data packets and identifies forwarding information for the data packet. In one implementation, routing logic 210 may identify an MPLS label associated with a data packet and identify a next hop for the data packet using the MPLS label.

LSP routing table 220 may include routing information for LSPs that MPLS POP 110-4 forms with other MPLS POPs. For example, in one implementation, LSP routing table 220 may include an incoming label field, an output interface field and an outgoing label field associated with a number of LSPs that include MPLS POP 110-4. In this case, routing logic 210 may access LSP routing table 220 to search for information corresponding to an incoming label to identify an output interface via which to forward the data packet. Routing logic 210 may also append the appropriate outgoing label on a packet forwarded to a next hop.

Output device 230 may include one or more queues via which the data packet will be output. In one implementation, output device 230 may include a number of queues associated with a number of different interfaces via which MPLS POP 110-4 may forward data packets.

In an exemplary implementation, MPLS POP 110-4 may form part of an LSP with a number of different nodes in network 100. For example, in one implementation, MPLS POP 110-4 may form part of an LSP with the other MPLS POPs (e.g., MPLS POPs 110-1, 110-2, 110-3, 110-5) and MPLS node 160. MPLS POPs 120 may similarly set up LSPs with each other and MPLS node 160.

MPLS POPs 110-150 and MPLS node 160, as described briefly above, may determine data forwarding information using labels attached to data packets. The components in the MPLS POPs (e.g., MPLS POPs 110-15) and MPLS node 160 may include software instructions contained in a computer-readable medium, such as a memory. A computer-readable medium may be defined as one or more memory devices and/or carrier waves. The software instructions may be read into memory from another computer-readable medium or from another device via a communication interface. The software instructions contained in memory may cause the various logic components to perform processes that will be described later. Alternatively, hardwired circuitry may be used in place of or in combination with software instructions to implement processes consistent with the principles of the invention. Thus, systems and methods described herein are not limited to any specific combination of hardware circuitry and software.

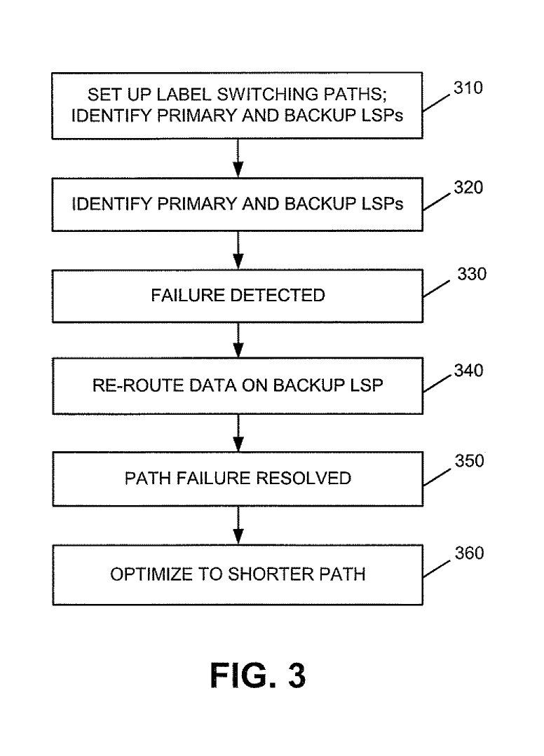

FIG. 3 is a flow diagram illustrating exemplary processing associated with routing data in network 100. In this example, processing may begin by setting up LSPs in network 100 (act 310). In an exemplary implementation, MPLS node 160 may act as a control device configured to set up various LSPs in network 100. For example, MPLS node 160 may wish to set up an LSP with MPLS POPs 110-1 though 110-5. In this case, MPLS node 160 may send label information to the MPLS POPs 110. Each of the MPLS POPs 110-1 through 110-5 may store the label information in its respective memory, such as its LSP routing table 220. As discussed previously, LSP routing table 220 may include information identifying incoming labels, outgoing interfaces corresponding to the incoming labels and outgoing labels to append to the data packets forwarded to the next hops. When a packet having an MPLS label is received by an MPLS POP, routing logic 210 searches LSP routing table 220 for the label and to identify an outgoing interface on which to forward the packet. Routing logic 210 also identifies an outgoing label in LSP routing table 220 for the data packet and appends the outgoing label to the packet. The outgoing label will then be used by the next hop to identify data forwarding information.

In an exemplary implementation, MPLS node 160 may set up two ring-like LSPs with MPLS POPs 110. That is, MPLS node 160 may set up a first LSP (e.g, illustrated by the arrows connecting MPLS node 160 with MPLS POPs 110-1 through 110-5 in a counterclockwise direction in FIG. 1) and a second LSP with MPLS POPs 110-1 through 110-5 in the opposite direction (e.g., illustrated by the arrows connecting MPLS node 160 and MPLS POPs 110-1 through 110-5 in the clockwise direction in FIG. 1). MPLS node 160 may set up two similar ring-like LSPs (i.e., one LSP in one direction and another LSP in the opposite direction) with MPLS nodes 120-1 through 120-5 in a similar manner.

In an exemplary implementation, MPLS node 160 may initiate the set up of the various LSPs by sending labels to, for example, MPLS POP 110-1 for the first LSP. The label information may then be forwarded hop by hop to the other MPLS POPs in the first LSP. MPLS node 160 may initiate the set up of the second LSP with respect to MPLS POPs 110 by sending labels to, for example, MPLS POP 110-5. MPLS POP 110-5 may then forward the label information to the other MPLS POPs 110. In this manner, two ring-like LSPs may be established. MPLS node 160 may set up the two LSPs with respect to MPLS POPs 120 in a similar manner.

MPLS node 160 may further set up LSPs with MPLS POPs 130, 140 and 150. In these cases, each LSP connecting MPLS node 160 with each of MPLS POPs 130, 140 and 150 may have a first LSP (illustrated by a pair of lines connecting MPLS POP 160 and the MPLS POP) and a second LSP (illustrated by a second pair of lines connecting MPLS node 160 and the corresponding MPLS POP).

MPLS node 160 may also designate which LSP is to act as a primary LSP when routing data to/from the various MPLS POPs (act 320). For example, MPLS node 160 may designate the LSP in the counterclockwise direction with respect to MPLS POPs 110 as the primary LSP and the LSP in the clockwise direction with respect to MPLS POPs 110 as a backup LSP. MPLS node 160 may similarly designate a primary and backup LSP for the other LSPs in network 100.

Assume that data is being routed in network 100 using the LSPs. That is, when data is received by one of MPLS POPs 110-150, routing logic 210 determines whether the data packet has a label and if so, routes the data packet to the next hop using information in LSP routing table 220. Further assume that one of the LSPs experiences a failure (act 330). For example, assume that the link between MPLS POP 110-4 and MPLS POP 110-5 fails and is temporarily unable to be used for routing data. MPLS POP 110-4 may detect this failure based on, for example, a lack of an acknowledgement message with respect to a signal transmitted to MPLS POP 110-5, a time out associated with a handshaking signal or some other failure indication associated with the link between MPLS POP 110-4 and 110-5.

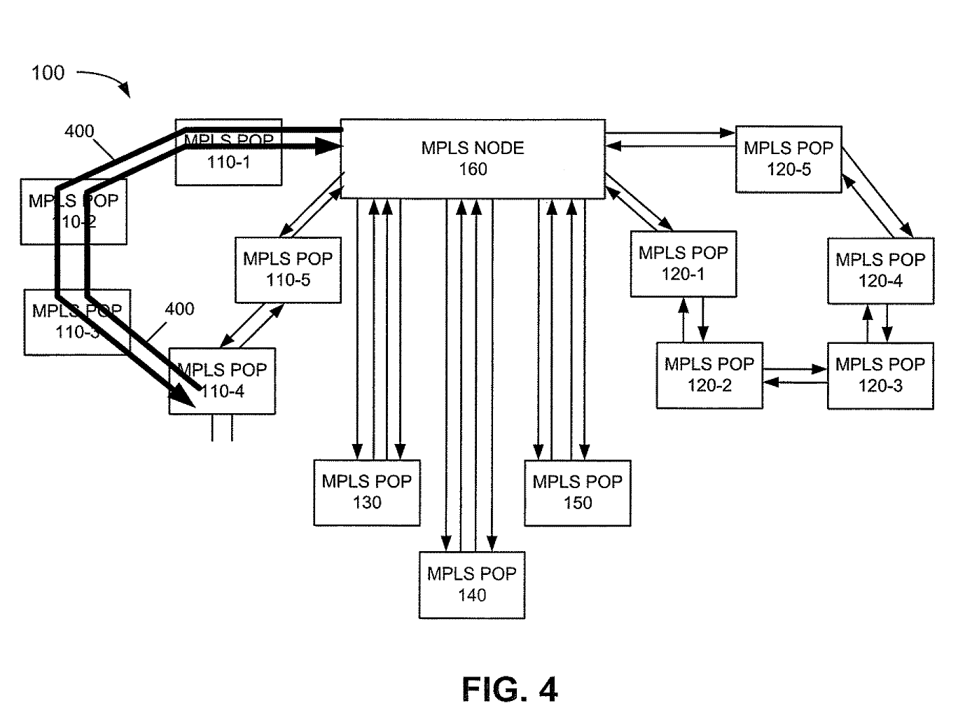

After the failure is detected, MPLS POP 110-4 may automatically re-route the data on the LSP that terminates at MPLS node 160 using the backup LSP (act 340). That is, routing logic 210 may determine that the backup LSP is to be used for routing data on the LSP to MPLS node 160. Routing logic 210 may then route the data intended for MPLS node 160 to MPLS POP 110-3, which will forward the data to MPLS POP 110-2, which will forward the data to MPLS POP 110-1, which will forward the data to MPLS node 160, as illustrated by path 400 in FIG. 4. In this manner, the pre-provisioned backup LSP may be used to re-route the data to its ultimate destination node (i.e., MPLS node 160 in this example). In addition, in some implementations, routing logic 210 may switch to the backup LSP in a “make before break” manner such that no packets will be dropped by MPLS POP 110-4 waiting for the backup LSP to be initialized and/or ready to receive/transmit data

MPLS node 160 may also use the backup LSP when routing data to, for example, MPLS node 110-4, as illustrated by path 410 in FIG. 4. This backup LSP may continue to be used by the various nodes in the LSP while the failure between MPLS POPs 110-4 and 110-5 exists.

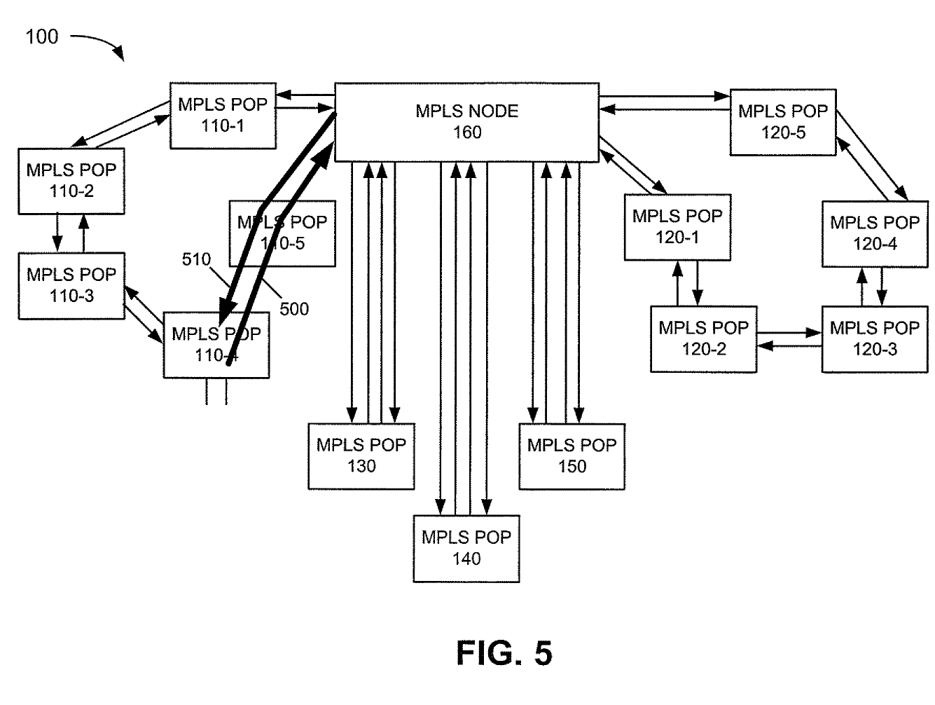

Assume that the failure in the LSP between MPLS POPs 110-4 and 110-5 is fixed or is resolved (act 350). In this case, MPLS POP 110-4 detects the availability of the link and routing logic 210 may re-optimize the LSP to MPLS node 160 (act 360). That is, routing logic 210 may begin re-using the primary LSP connecting MPLS POP 110-4 to MPLS node 160. In this case, data intended for MPLS node 160 will be routed via the primary LSP, indicated by path 500 in FIG. 5, which is the shortest route to MPLS node 160. Similarly, when MPLS node 160 is routing data to MPLS POP 110-4 via label switching, MPLS node 160 may use the shortest LSP, indicated by path 510 in FIG. 5. In addition, routing logic 210 may switch to the primary LSP in a “make before break” manner such that no packets will be dropped while the switch to the primary LSP occurs.

In some implementations, an MPLS fast reroute function may be enabled in MPLS POPs 110-1 through 110-5. In this case, no pre-provisioned backup LSP may be necessary. For example, if an LSP, or portion of an LSP becomes unavailable, such as the portion of the LSP between MPLS POPs 110-4 and 110-5, routing logic 210 in MPLS POP 110-4 may automatically signal MPLS POP 110-3 that a fast reroute operation is to occur and to set up an LSP with MPLS POPs 110-3, 110-2, 110-1 and MPLS node 160. In an exemplary implementation, routing logic 210 may then forward the data packet intended for MPLS node 160 to MPLS POP 1110-3, which will forward the data packet on the newly formed LSP in a very short period with minimal latency. For example, the backup LSP may be set up in 50 milliseconds or less with the other MPLS POPs 110 and MPLS node 160.

In the examples above, the switch from the primary to backup LSP was described as being caused by a link failure and/or device failure. In other instances, the switch may occur due to congestion and/or latency problems associated with a particular device/portion of the LSP. That is, if a particular portion of an LSP is experiencing latency problems that may, for example, make it unable to provide a desired service level, such as a guaranteed level of service associated with a service level agreement (SLA), MPLS node 160 or another device in network 100 may signal MPLS nodes 110 to switch to the backup LSP. In each case, when the problem is resolved (e.g., latency, failure, etc.), MPLS POPs 110 may switch back to the primary LSP. In this manner routing in network 100 may be optimized.

Implementations described above use a ring-like restoration mechanism to efficiently re-route data when a problem occurs. Such restoration mechanisms may be used in lieu of lower layer ring technologies, such as uni-directional path switched ring (UPSR), bi-directional line switched ring (BLSR) (SONET) or resilient packet ring (RPR) (Ethernet) technologies.

In addition, in some cases, various processes executed by MPLS node 160 and/or various MPLS POPs 110 may inject test packets in network 100 to identify potential problems, such as latency problems. In this case, if some of the hops in an LSP and/or links in the LSP are running without any problems, while others are not running at full capability or capacity, MPLS node 160 may decide to switch all or a portion of the traffic to a backup LSP.

Implementations described herein provide for routing data within a network via a primary path or a backup path. The paths may be LSPs formed in a ring-like manner that allow for data to be re-routed when a problem occurs.

The foregoing description of exemplary implementations provides illustration and description, but is not intended to be exhaustive or to limit the invention to the precise form disclosed. Modifications and variations are possible in light of the above teachings or may be acquired from practice of the invention.

For example, various features have been described above with respect to MPLS node 160 and various MPLS POPs 110. In some implementations, the functions performed by MPLS node 160 and MPLS POPs 110 may be performed by a single component/device. In other implementations, some of the functions described as being performed by one of these components may be performed the other one of these components or another device/component.

In addition, while series of acts have been described with respect to FIG. 3, the order of the acts may be varied in other implementations. Moreover, non-dependent acts may be implemented in parallel.

It will be apparent to one of ordinary skill in the art that various features described above may be implemented in many different forms of software, firmware, and hardware in the implementations illustrated in the figures. The actual software code or specialized control hardware used to implement the various features is not limiting of the invention. Thus, the operation and behavior of the features of the invention were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as a processor, a microprocessor, an application specific integrated circuit, or a field programmable gate array, software, or a combination of hardware and software.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. In a network including a plurality of nodes configured to support multi-protocol label switching, a method comprising:
forming a primary label switching path (LSP) from a first one of the plurality of nodes to the other ones of the plurality of nodes in a first direction, the primary LSP forming a first ring-like LSP including each of the plurality of nodes; and
forming a secondary LSP from the first one of the plurality of nodes to the other ones of the plurality of nodes in a second direction opposite the first direction, the secondary LSP forming a second ring-like LSP including each of the plurality of nodes.

2. The method of claim 1, further comprising:
detecting a failure in the primary LSP; and
automatically routing data on the secondary LSP.

3. The method of claim 2, further comprising:
detecting a recovery in the primary LSP; and
automatically switching back to routing data on the primary LSP in response to the recovery.

4. The method of claim 1, further comprising:
detecting that a latency associated with routing data on the primary LSP is above a predetermined threshold; and
automatically routing data on the secondary LSP in response to the detected latency.

5. The method of claim 4, further comprising:
detecting that the latency associated with routing data on the primary LSP is below the predetermined threshold; and
automatically switching back to routing data on the primary LSP in response to the latency being below the predetermined threshold.

6. The method of claim 1, wherein the first node comprises a controller node and the forming a primary LSP comprises:
forming the primary LSP from the controller node to each of the plurality of nodes and back to the controller node to form the first ring-like LSP.

7. The method of claim 1, wherein the forming a primary LSP comprises:
forming the primary LSP from the first node to each of the plurality of nodes and back to the first node to form the first ring-like LSP, and
wherein the forming the secondary LSP comprises:
forming the secondary LSP from the first node to each of the plurality of nodes and back to the first node to form the second ring-like LSP.

8. A system comprising:
a plurality of nodes configured to support multi-protocol label switching, each of the nodes comprising:
logic configured to:
determine that a problem exists in at least a portion of a primary label switching path (LSP) connecting each of the plurality of nodes in a ring-like configuration,
identify a backup LSP, the backup LSP connecting each of the plurality of nodes in a ring-like configuration, and
automatically switching routing of data from the primary LSP to the backup LSP in response to the problem.

9. The system of claim 8, wherein the backup LSP routes data in an opposite direction with respect to the plurality of nodes than the primary LSP.

10. The system of claim 8, wherein a first one of the plurality of nodes comprises a control node configured to initiate setting up the primary LSP and the backup LSP.

11. The system of claim 8, wherein each of the plurality of nodes further comprises:
a label switching table configured to store incoming label information and outgoing interface information corresponding to the incoming label information.

12. The system of claim 11, wherein the logic is further configured to:
identify a label included with a data packet,
access the label switching table to identify an outgoing interface on which to forward the data packet,
identify an outgoing label to append to the data packet, and
forward the data packet with the outgoing label on the identified outgoing interface.

13. The system of claim 8, wherein when determining that a problem exists, the logic is configured to detect a link failure associated with the primary LSP.

14. The system of claim 8, wherein when determining that a problem exists, the logic is configured to detect a latency problem in the primary LSP.

15. The system of claim 8, wherein the logic is further configured to:
detect that the problem has been resolved, and
automatically switch routing of data from the backup LSP to the primary LSP in response to detecting that the problem has been resolved.

16. A method, comprising:
setting up a first label switching path (LSP) including a plurality of nodes, the first LSP connecting the plurality of nodes in a first ring-like configuration and being used to route data in a first direction; and
setting up a second LSP including the plurality of nodes, the second LSP connecting the plurality of nodes in a second ring-like configuration and being used to route data in a second direction opposite the first direction.

17. The method of claim 16, further comprising:
detecting a failure in the first LSP; and
automatically routing data on the second LSP in response to the failure.

18. The method of claim 17, further comprising:
detecting a recovery in the first LSP; and
automatically routing data on the first LSP in response to the recover.

19. The method of claim 16, further comprising:
detecting congestion in the first LSP; and
automatically routing data on the second LSP in response to the congestion.

20. The method of claim 19, further comprising:
determining that the congestion has been resolved in the first LSP; and
automatically routing data on the first LSP in response to the resolution of the congestion.
